(19) United States
(12) Patent Application Publication
(10) Pub. No.: US 2004/0048002 A1
(43) Pub. Date: Mar. 11, 2004

(54) Method for coating objects

(76) Inventor: J. Michael Shifflette, Fort Lauderdale, FL (US)

Correspondence Address: MICHAEL C. CESARANO, SUNTRUST INTERNATIONAL CENTER, 28TH FLOOR, 1 S.E. 3RD AVENUE, MIAMI, FL, 33131-1714, US

(21) Appl. No.: 10/241,130

(22) Filed: Sep. 11, 2002

(51) Int. Cl. B05D 1/02; B05D 1/18; B05D 3/00

(52) U.S. Cl. 427/430.1; 427/398.1; 427/421

(57) ABSTRACT

A method for applying a coating to an object comprises the steps of preparing a coating solution comprising a solvent and a solute composition of the desired coating, cooling an object to a temperature that is below the freezing temperature of the coating solution, immersing the object into the coating solution, leaving the object immersed in the coating solution long enough for a frozen layer of solution to form on the object, removing the object from the coating solution, removing any excess liquid from the frozen surface, and allowing the object to cure by placing it in an environment in which the solvent is released from said frozen layer.

### BACKGROUND OF THE INVENTION

There is, in many industries, a need for objects to have coatings applied to them that make them suitable for particular purposes. For example, in the medical industry there is a need for metallic instruments and devices to have coatings that are able to be sterilized, be free of static electricity, or that have other characteristics that are beneficial when the instrument or device comes into contact with human or animal tissue. As used herein, the term “object” will refer to any object whose purpose or function is improved through the application of a coating having specific properties, and the method of this invention is not limited to medical applications.

The obvious methods of spraying, dipping and rolling an object in a liquid coating material have a common shortcoming: characteristics of a liquid dominate the physics of the coating application, causing the liquid to form a coating that is thicker in some areas than in others. The coatings are typically formed from a solution having a polymer, a drug or other agent having desirable properties for the intended application, and a solvent having characteristic values of density, surface tension, viscosity, adhesion, cohesion and wettability of the substrate. When the coating is applied by traditional methods, the liquid's density, under the influence of gravity, tends to make the coating pool toward earth. Resisting this tendency at least somewhat is the solution's viscosity and, to an extent, surface tension, although pooling will generally occur under even the most beneficial combinations of viscosity and surface tension. The effectiveness of the coating may also be affected by the wettability of the substrate, which may resist adhesion of the coating solution to the substrate. Thus, it is clear that the characteristics of liquids used in a liquid coating process dominate the process and prevent the application of a smooth, conformal coating layer. What is needed is a method of applying a coating to an object that avoids the known drawbacks of traditional liquid coating methods.

### SUMMARY OF THE INVENTION

In accordance with the method of this invention, application of a coating solution that is in a phase other than liquid will alleviate the problems associated with liquid applications. The coating solution generally will consist of a polymer to act as a matrix for coating agent retention or elution, a coating agent having beneficial or desired properties, and a solvent. By lowering the surface temperature of the object to be coated to a uniform temperature that is below the freezing point of the solution, which consists of a solvent and a solute that is dissolved in the solvent, the object may be dipped into a liquid solution or exposed to an atomized spray such that the part of the solvent and the solute that come into direct contact with the object freeze to form a thin layer on the surface of those portions of the object that are exposed to the solution. Where a coating is desired to cover only part of an object, only that portion of the object to be covered need be exposed to the coating solution. Since the frozen layer is in the form of a solid, the dynamic characteristics of a liquid under gravity are not present, and the surface coating on the object may be applied to have a uniform thickness throughout. Alternatively, by differential cooling of the object to cause some surface areas to be cooler than others, it will be possible to apply coatings whose initial frozen layer thickness, and final coating thickness, are non-uniform, but nonetheless desirable for the particular object being coated.

The composition of the surface of the object (the “substrate”) may be such that different coatings will have different surface adherence characteristics. Accordingly, the coating composition should be selected to provide desired coating and adherence characteristics depending upon whether the substrate is metallic, plastic, ceramic, or some other composition.

The object and coating may then be subjected to any one of a number of known processes to remove any unfrozen liquid above the frozen layer, leaving only a solid, frozen layer of the coating solution on the object. Processes for removing unfrozen liquid include vibration, shock, centrifugal force, or exposure to an air jet. If a thicker coating is desired than is produced by a single cycle of cooling and immersion, the process may be repeated as necessary until the desired thickness is obtained. Once the object is covered with a frozen coating solution, the coating may be cured by allowing the object to stand while the solvent within the coating is released to the immediate environment. The curing process may be enhanced by placing the object in an environment of reduced pressure that may be heated for greater effectiveness, causing the solvent within the coating to be released or removed from the coating. At this point, an intermediate state may be encountered in which the coating is no longer frozen and curing has not yet taken place. Following the curing process, those portions of the object that were exposed to the solution will be covered with a coating of the solute that adheres to the object and provides the desired beneficial properties of the coating.

It is an object of this invention to provide a method of coating an object with a coating having desirable properties and that is free from irregularities caused by the pooling of liquid in a gravitational field.

It is a further object of this invention to provide a method of applying a coating that is free from irregularities to only those portions of an object upon which a coating is desired.

It is another object of this invention to provide a method of applying to an object a coating of uniform thickness.

It is yet a further object of this invention to provide a method of applying to an object a coating having a thickness that is variable in accordance with predetermined parameters.

A further object of the invention is to provide a method of applying a coating to an object either through the process of immersion in a liquid or by spraying the object.

These and other objects of the invention will become apparent in the following description of the invention.

### BRIEF DESCRIPTION OF THE DRAWINGS

FIG. 1 is a flow chart showing the steps for practicing the method of this invention.

FIGS. 2a-2d depict the primary steps of the process of this invention as applied to an object.

FIG. 3 shows an alternative method of applying a coating in accordance with the invention.

FIG. 4a shows a cross section of the object in which the coating has been applied unevenly.

FIG. 4b shows the object having an evenly applied coating using one embodiment of the process of this invention.

FIGS. 5a and 5b show the method of applying a coating to produce different thicknesses at various points on an object.

FIGS. 6a-6c depict the method of applying a coating to only a portion of an object.

### DETAILED DESCRIPTION OF THE PREFERRED EMBODIMENTS

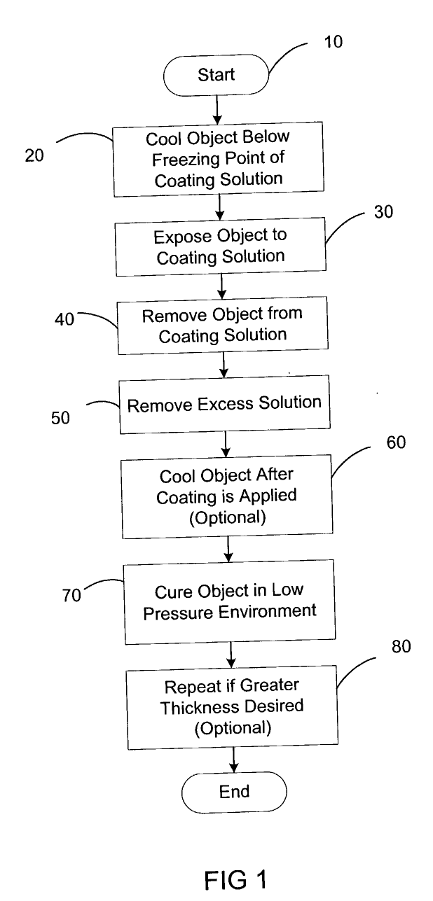

As depicted in FIG. 1, the method of applying and curing a coating upon an object is a process comprised of a number of steps. Once the object to be coated has been cleaned or otherwise prepared, as at step 10, it is cooled to a very low temperature 20. Although cooling may be done in any suitable fashion, such as refrigeration or exposure to a current of cold air, immersion in a cryogenic liquid, such as nitrogen (N₂), has been effective and is a preferred method of accomplishing the step of cooling the object. The cooled device is then exposed to the solution of solvent and solute 30, which may occur through immersion in a container of liquid solution or being subjected to a spray or mist of the solution. The low temperature and heat capacity of the object will cause a layer of solution to freeze and solidify on the exposed surface of the object, and the solidified layer will contain at least some solute.

The object, now covered with a layer of solution, is then removed from the liquid or mist coating solution 40, and any liquid adhering to the solidified layer may be removed from the object by shock, vibration, centrifugal force, or gas jet, 50. The removal of the adhered liquid will leave an object having a frozen coat of the coating solution. If desired or necessary, the object may be further cooled by reimmersion in the cryogenic liquid 60, to bring the temperature of the object and coating well below the melting temperature of the coating solution, thus fully solidifying the frozen solution layer.

There are circumstances in which a second or thicker coating may be desired. Depending upon the specific coating being employed, and the uses to which the object will be put, a second coating may be applied at various points in the coating process. For certain applications, a second coating may be applied this point by reexposing the object to the coating solution 80.

Once the object is coated with a solid layer of the coating solution that is free from irregularities related to the pooling of liquid in a gravitational field, the solvent in the solution may be removed from the coating by placing the object in an environment of ambient air and allowing the solvent to escape into the air. This process may be enhanced by placing the object in an environment of reduced pressure 70, allowing the solvent to escape from the coating layer, and leaving the solute uniformly deposited on the object. If the object is maintained at a temperature below the freezing point of the solvent, the solvent may sublimate directly from the frozen state into a gaseous state. If desired, however, the object may also be heated within the reduced pressure environment, bringing the coating to an intermediate state, and causing the vaporizing solvent to transition through a liquid phase before evaporating. As previously noted, depending upon the characteristics and purpose of the coating, another coating may be applied by reexposure of the object to the coating solution at this point in the process 80.

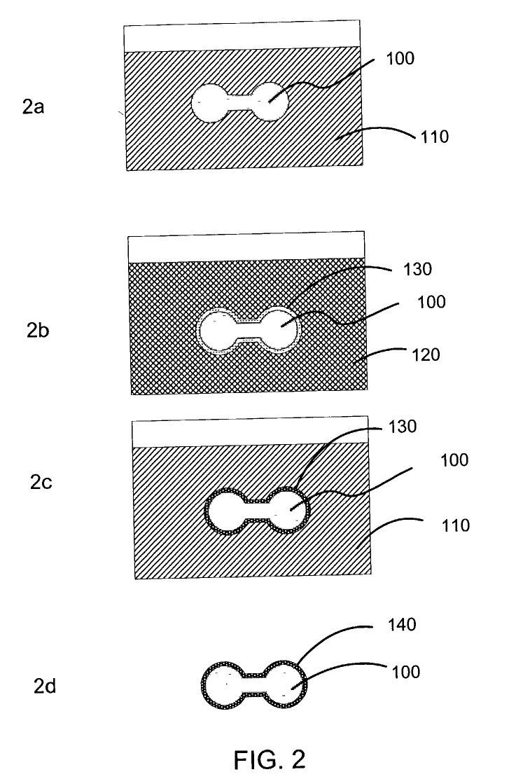

In FIG. 2, a physical apparatus for practicing the preferred embodiment of the process is shown. At FIG. 2a, a hypothetical object to be coated 100 is immersed in a cooling medium 110. The cooling medium can be any suitable medium, and a cryogenic liquid, preferably nitrogen, will cool the device sufficiently for most coating solutions to be applied through the method of this invention. At FIG. 2b, the cooled device 100 has been immersed within a coating solution 120 whose freezing point is higher than the temperature of the cooled object. Upon immersion of the object into the coating solution, a frozen layer of the solution 130 forms on the exterior surfaces of the object 100. The device may then be reimmersed in the original cooling medium, or in some other cooling medium 110 to fix the frozen layer of coating on the device. This optional step may be used when it is contemplated that more than one coating of solution will be applied, or when other circumstances indicate that a second cooling of the device will assist in achieving a desired coating. Curing takes place when the object is placed in an environment in which the solvent will escape from the coating solution, as at FIG. 2d. The dry coating 140 remains on the object 100 after the solvent has been released.

The processes of this invention involve thermodynamic activity that is described hereinafter. When the object is immersed in a cryogenic liquid, such as nitrogen (N₂), it will come into thermal equilibrium with the liquid at or below the evaporation temperature of the liquid. For nitrogen (N₂), the evaporation temperature is −196° C.

The heat energy of the object available to solidify solvent (T_{f(reeze)} known) is: q=mCₚ(T_{f}+196), where m is the mass of the object (in grams), Cₚ is the “specific heat” of the object (J/gK where J is joules and gK is grams times degrees Kelvin) and q is the “heat” (in joules) and T_{f} is in degrees Celsius. Immersing the cooled object in the coating solution (at a selected temperature T_{c}) will cause a transfer of heat from the solution to the object, ultimately bringing the temperature of the object to very near T_{c}. The heat transferred from the solution to the object will cause the temperature of the solvent next to the object to drop below its freezing point and solidify, becoming attached to the object's surface (the source of the “cold”).

The heat required to solidify the solvent in the process is: q=m[Cₚ(T_{f}−T_{c})−h_{fus}] where: m is the mass of solvent (g), Cₚ is the “specific heat” of the solvent-solute solution (J/gK) and h_{fus} is the enthalpy of fusion, or the “latent heat of fusion” (J/g). The heat available to solidify solvent will be equal to the heat that is removed from the object, and may be determined by the equation:

m_{coating}[C_{p,coat}(T_{f}−T_{c})−h_{fus}]=m_{object}C_{p,object}(T_{f}+196)

which may be transformed to be:

m_{coating}=m_{object}C_{p,object}(T_{f}+196)/[C_{p,coat}(T_{f}−T_{c})−h_{fus}]

The concentration of solute in the solidified solvent will depend upon a number of factors, including precipitation of the solute at depressed temperatures. In other words, the solute concentration in the solid phase is formulation and process specific. However, viscous forces in the cold solvent also tend to keep the precipitate in place.

Upon removal of the object from the liquid, two phases of the solvent-solute solution will exist on the object: solid and liquid. The liquid will be viscous because it is cold and is transferring heat with the surroundings and with the frozen solvent-solute layer on the object. The length of time that the object is immersed in the solvent-solute solution is an important process consideration. The final temperature of the object should be below T_{f}, in order to ensure that the solidified solution remains solid.

Removal of the excess liquid will result in a coating that is free from irregularities that are caused by the pooling of liquid in a gravitational field. Two of the liquid forces, viscosity and cohesion, are maximized by low temperature, and dominate the physics of the liquid thickness. To achieve a uniform coating, liquid should be removed, leaving only the solid phase layer on the object.

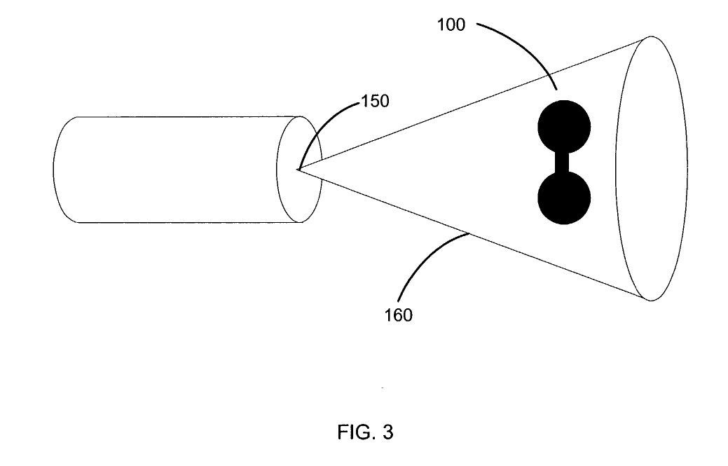

Although immersion into a liquid solution is a preferred method of exposing the object to the coating material, althernative embodiments, such as placing the object in a spray or mist of coating solution, as depicted in FIG. 3, may have advantages when applying certain coatings, or when working within unusual environments. For example, when working in gravity-free environments, such as would be encountered in an Earth-orbiting or space-bound manufacturing facility, the use of a sprayed solution may be required to obtain a satisfactory coating. This embodiment is depicted in FIG. 3, in which an object 100 has been cooled and placed within a spray 160 comprised of the coating solution. A desired spray pattern is generated by nozzle 150. The spray may be electrostatically attracted to the object, or the object may be rotated or otherwise moved during the coating process. Upon contacting the cold surface of the object, the spray droplets will conform to the surface immediately prior to freezing, and will form a frozen coating on exposed surfaces of the object. The spray may be generated from a number of commercially available sources including, but not limited to, ultrasonic spray nozzles and air atomizing spray nozzles. The steps of cooling, recoating or recooling, if desired, and curing may be as described earlier.

While the method of this invention normally produces a coating that has a more or less uniform thickness across the exposed surface of most objects, there are a number of factors, including objects having unusual shapes that may cause the thickness of a coating to vary. In some cases, it may be desirable to produce a coating having a different thickness over different surface areas of the object. In other cases, such variances may not be desired, and steps must be taken to avoid their occurrence. In either case, the thickness of the coating may be established by adjusting the temperature of the object's surface prior to exposure of the surface to the coating solution to cause a frozen layer of a predetermined thickness to form. The application of previously described mathematical formulae to determine the appropriate temperatures of the coating solution and of the surface and immediately adjacent areas of the object, will result in the formation upon that surface of a frozen layer having the desired thickness.

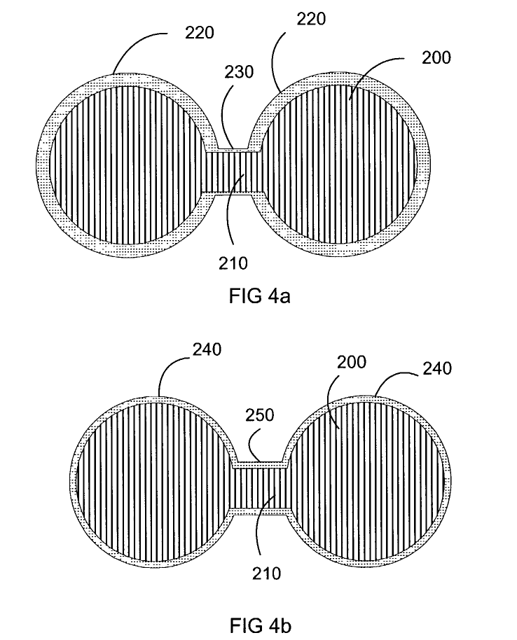

FIGS. 4a and 4b demonstrate the use of this technique to produce a uniform coating upon an entire object that has diverse shapes. In FIG. 4a, each end of an object is comprised of a spherical mass 200 having a relatively small surface-to-mass ratio, while the connecting rod 210 has a smaller mass with a larger surface-to-mass ratio. If the object is cooled to a uniform temperature before being immersed in the relatively warmer coating solution, upon immersion the connecting rod will receive heat from the coating solution across the large surface area, causing the temperature of that part of the object to rise relatively quickly. The result is that a relatively thin frozen layer 230 will form upon the connecting rod 210. The spherical ends 200, however, will experience a much slower rise in temperature, as a greater amount of heat energy will be required to raise the temperatures of the spherical masses, and that heat must be transferred through the relatively small surface area of the spheres. If the object is removed from the coating solution before all parts have reached thermal equilibrium, the frozen layer 220 on the surface of each sphere 200 will be thicker than the frozen layer 230 on the connecting rod 210.

This condition can be mitigated or alleviated by cooling the connecting rod to a temperature that is cooler than the temperature of the spheres prior to immersing the object within the coating solution. One method of accomplishing the differential cooling is to start with all parts of the object at a uniform temperature prior to initial cooling. The object may then be differentially cooled by immersion in a cryogenic liquid or other cooling medium for a predetermined length of time that is shorter than the time needed to cool all parts of the object to a uniform temperature. Because the same heat transfer characteristics apply to the initial immersion of the relatively warm object into the cryogenic liquid, initial temperature gradients will be higher for the connecting rod than for the spheres, indicating that the reduction in the temperature of the connecting rod occurs much more rapidly than the reduction in temperature of the spherical areas. If the object is removed before all areas reach the same temperature, and is immediately immersed into the coating solution, the relatively cooler connecting rod will cause a frozen layer to form that, initially, will thicken more rapidly than the frozen layer formed upon the spheres.

In FIG. 4b, as the connecting rod 210 receives heat from the coating solution, its temperature will quickly rise, and the rate at which the liquid solution is converted to a frozen layer 250 at the interface between them will slow down as the temperature rises. The spherical areas 200, starting at relatively warmer temperatures, will initially form frozen layers 240 that are not as thick as the frozen layer at the connecting rod. However, the temperature of the spherical areas will rise more slowly, owing to their greater mass, and the frozen layers 240 will continue to thicken around the spherical portions until they reaches the same thickness as the frozen layer at the connecting rod 250. If the object is removed from the coating solution at this point, the frozen layer across both the connecting rod and spherical portions will be very close to uniform. Although the process for obtaining greater uniformity in a coating across an object having diverse shapes is dependent upon a number of variables, experimentation with cooling and immersion times and temperatures may be expected to produce a coating of acceptable uniformity for most practical applications.

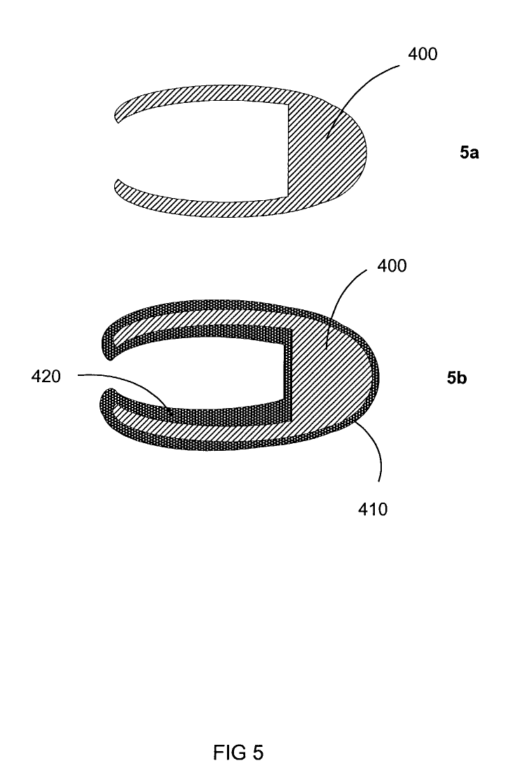

The phenomenon of differential cooling will control the thickness of the coating on an object in which it is desired that a variable thickness coating be applied to various parts of an object. FIG. 5a depicts an object 400 upon which it is desired to apply a thicker coating to the “arms” of the object than to the other portions of the object. Because a greater thickness of the frozen coating is desired upon the arms, they will be cooled to a lower temperature before the object is immersed in the coating solution. The lower temperature of the “arms” will cause the frozen layer to form to a greater thickness on the arms than is formed elsewhere. At FIG. 5b, it may be seen that the frozen layer has formed to a greater thickness on the “arms” of the object 420 than on the “body” of the object 410. After the coating has cured, there will be a thicker coating on the arms than on the body of the object.

Where differential cooling of different parts of an object is intended, cooling means other than, or in addition to, immersion in a cryogenic liquid may be required. Such differential cooling could include, for example, cryogenic immersion followed by the application of warm air or other heat conductors to selected parts of the object., or selective cooling by placing cooling coils in proximity to those parts of an object whose temperatures are to be relatively cooler than other parts.

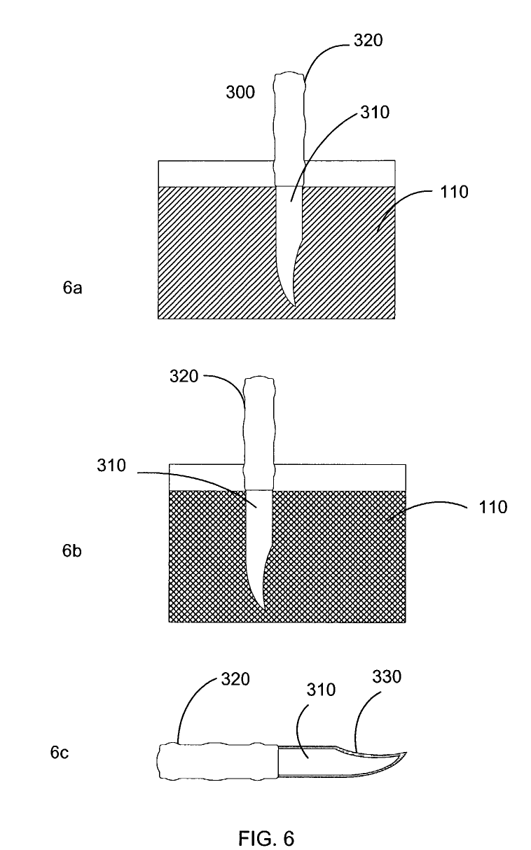

At FIG. 6, a preferred embodiment of the method of coating only a portion of an object is depicted. At FIG. 6a, an knife-like object 300 is shown in which the surface of the blade 310, but not the haft 320, is to be coated. The blade is immersed in a cryogenic liquid 110 and at FIG. 6b, after sufficient cooling has taken place, is next immersed in a coating solution 120. After the formation of a frozen layer of coating solution on the exposed blade 310, the object is removed and allowed to cure, at FIG. 6c, and after curing, the coating 330 remains as a coating only upon the blade 310.

Under normal conditions, when an object and its solidified solution layer are removed from the solution, they will be at a low temperature, and will absorb heat from the surroundings unless the surrounding temperature is controlled. In some applications it may be desirable to fix the frozen coating solution in place by reimmersing it in a cryogenic liquid. Liquid nitrogen (N₂) is a generally acceptable cooling liquid for this purpose. So long as no component in the solid solution is soluble in the cryogenic liquid, there should be no change in the mass, distribution or composition of the solvent-solute layer, and it may cooled well below the freezing point of the solvent merely to fully solidify it for handling and subsequent processing.

The steps of cooling the object, exposing it to a solvent-solute solution, and removing unfrozen liquid, may be carried out in a very low humidity environment. Since the temperatures of the object and the solid coating are both well below the dew point of ambient atmosphere, water vapor in the ambient atmosphere may otherwise condense on the cold surfaces, and may well freeze. Such unwanted water will transfer heat to the object, and would detract from the efficiency of the process and introduce unwanted water into the solution.

The object may be subjected to vacuum solvent removal, but consideration should be given to using a cycle that permits the solvent/solute mixture to achieve the liquid state. The reason for this is that lyophilization, or freeze-drying, is a process of vacuum removal of solid phase solvents from a solution or suspension, leaving a solvent-free matrix of the solute. Often, however, these matrices are of a low-density, fragile nature (like cotton candy), and may leave voids or otherwise be unsuitable for use as an object coating.

In the process of this invention, as some solvent is removed, the concentration of the solute will increase, and the resulting solution will be very viscous and cohesive. The viscosity of the liquid will minimize creep or migration of the solution. In the preferred embodiment, the liquid phase will be attained because the final coating should be dense and durable, and free of voids that arise from lyophilization. Near the end of the cycle, the coated object may be dried with dry heat at atmospheric or reduced pressure. These steps will ensure that the coating is void free and of maximum mechanical durability.

The process or steps hereof may be repeated without limitation, and any or all of the process variables, including the chemistry of the solvent-solute solution, may be altered for any of the repetitions. Using the methods of this invention, surface activating agents or primers, and external hard coatings may be effectively applied, and concentration gradients within the coating are very realizable.

The invention has been described with reference to preferred embodiments and modifications and alterations will occur to others upon a reading and understanding of the specification. It is my intention to include all such modifications and alterations insofar as they come within the scope of the appended claims or the equivalents thereof.

1. A method for applying a coating to the surface of an object comprising the steps of:
preparing a coating solution comprising a solvent and a solute composition of the desired coating,
cooling a surface of an object to a temperature that is below the freezing temperature of said coating solution,
immersing said surface into said coating solution,
leaving said surface immersed in said coating solution until a frozen layer of solution has formed on said surface,
removing said surface from said coating solution,
locating said surface in an environment in which said solvent is released from said frozen layer.

2. The method for applying a coating to a surface of an object as claimed in claim 1 wherein said step of cooling said surface further comprises immersing said surface in a cryogenic liquid.

3. A method for applying a coating to a surface of an object as claimed in claim 2 wherein said surface comprises substantially all the surfaces of said object.

4. The method for applying a coating to a surface of an object as claimed in claim 1 wherein said solute composition comprises a polymer and an agent having predetermined desired properties.

5. The method for applying a coating to a surface of an object as claimed in claim 1, further comprising the step of removing unfrozen liquid from the surface formed by said frozen solution after said surface formed by said frozen solution has been removed from said coating solution.

6. The method for applying a coating to a surface of an object as claimed in claim 5, wherein said step of removing unfrozen liquid from said surface formed by said frozen solution further comprises vibrating said object.

7. The method for applying a coating to a surface of an object as claimed in claim 5, wherein said step of removing unfrozen liquid from said surface of said frozen solution further comprises placing said object under conditions of physical shock.

8. The method for applying a coating to a surface of an object as claimed in claim 5, wherein said step of removing unfrozen liquid from said surface of said frozen solution further comprises subjecting said object to centrifugal force.

9. The method for applying a coating to a surface of an object as claimed in claim 5, wherein said step of removing excess liquid from said surface of said frozen solution further comprises placing said object within a gaseous stream.

10. The method for applying a coating to a surface of an object as claimed in claim 5, wherein said coating may be applied to any desired thickness by repeatedly performing the steps of cooling said surface of said object to a temperature that is below the freezing temperature of said coating solution, immersing said surface of said object in said coating solution until a frozen layer is formed on said object, and removing said unfrozen liquid from the surface of said frozen layer.

11. The method for applying a coating to a surface of an object as claimed in claim 5, wherein said step of removing said solvent from said frozen layer further comprises placing said surface of said object in an environment of reduced pressure.

12. The method for applying a coating to a surface of an object as claimed in claim 11, wherein said step of removing said solvent from said frozen layer further comprises subjecting said surface of said object to heat.

13. A method for applying a coating to a surface of an object comprising the steps of:
preparing a composition comprising a solvent and a solute of the desired coating,
cooling said surface of said object to a temperature that is lower than the freezing point of said mixture,
atomizing said composition into a vaporous stream,
exposing said surface of said object to said vaporous stream such that particles of said vaporous stream contact said surface of said object to form a frozen layer of solvent and solute composition upon said surface of said object,
removing said surface of said object from said vaporous stream,
situating said surface of said object in an environment in which the temperature of said surface of said object is brought to a temperature that is greater than the freezing point of said composition such that said solvent is released from said solvent and solute composition.

14. The method for applying a coating to a surface of an object as claimed in claim 13, wherein said step of atomizing said mixture further comprises bringing said vaporous stream to a predetermined density, pressure, and temperature such that said molecules of said vaporous stream contact said surface of said object to form a frozen layer of solvent and solute composition upon said surface.

15. The method for applying a coating to a surface of an object as claimed in claim 14, wherein said step of releasing said solvent from said solvent and solute composition further comprises placing said surface of said object within an environment of reduced air pressure.

16. The method for applying a coating to a surface of an object as claimed in claim 14, wherein said step of releasing said solvent from said solvent and solute composition further comprises placing said surface of said object in an environment in which the temperature is raised.

17. A method for applying a coating to an object comprising a plurality of shapes, each shape having surfaces and interior portions and comprising a surface to mass ratio, at least two of said shapes having differing surface to mass ratios, comprising the steps of:
preparing a solution comprising solvent and a solute, said solute further comprising a desired coating,
immersing said at least two of said shapes having differing surface to mass ratios into a cooling medium until said shapes are at temperatures that are below the freezing point of said solution,
removing said at least two of said shapes from said cooling medium,
immersing said at least two of said shapes into said solution until a frozen layer has been formed upon each of said at least two of said shapes,
removing said at least two of said shapes from said solution,
removing unfrozen liquid from each said frozen coating,
situating said at least two of said shapes in an environment in which said solvent is released from each said frozen layer to leave a coating on said at least two of said shapes.

18. A method for applying a coating to an object as claimed in claim 17, further comprising the step of removing said at least two of said shapes from said cooling medium at a time when the temperatures of said at least two of said shapes are different

19. A method for applying a coating to an object as claimed in claim 17, further comprising the step of removing said at least two of said shapes from said solution at a time when the thicknesses of said frozen layers formed on said at least two of said shapes is different.

20. A method for applying a coating to an object comprising a plurality of shapes, each shape having surfaces and interior portions and comprising a surface to mass ratio, at least two of said shapes having differing surface to mass ratios, comprising the steps of:
preparing a composition comprising a solvent and a solute of the desired coating,
cooling said at least two of said shapes having differing surface to mass ratios in a cooling medium to temperatures that are below the freezing point of said composition,
atomizing said composition into a vaporous stream,
exposing said at least two of said shapes to said vaporous stream such that particles of said vaporous stream contact said at least two of said shapes to form a frozen layer of solvent and solute composition upon said at least two of said shapes,
removing said at least two of said shapes from said vaporous stream,
situating said at least two of said shapes in an environment in which said solvent is released from each said frozen layer to leave a coating on said at least two of said shapes.
